(19) United States
(12) Patent Application Publication
(10) Pub. No.: US 2025/0275041 A1
(43) Pub. Date: Aug. 28, 2025

(54) TOGGLE SWITCH CONTROL FOR LIGHTING DEVICE ACCESSORIES

(71) Applicant: Feit Electric Company, Inc., Pico Rivera, CA (US)

(72) Inventors: Alan Barry FEIT, Pico Rivera, CA (US); Brian HALLIWELL, Pico Rivera, CA (US); Shane IGO, Pico Rivera, CA (US)

(21) Appl. No.: 19/066,087

(22) Filed: Feb. 27, 2025

Related U.S. Application Data
(60) Provisional application No. 63/558,326, filed on Feb. 27, 2024.

(51) Int. Cl. H05B 47/17; F21V 23/04; F21V 33/00; F21Y 113/00; F21Y 115/10; H05B 45/20; H05B 47/155; H05B 47/16; H05B 47/19

(52) U.S. Cl. CPC H05B 47/17; F21V 23/0435; F21V 33/0096; H05B 45/20; H05B 47/155; H05B 47/16; H05B 47/19; F21Y 2113/30; F21Y 2115/10

(57) ABSTRACT

A lighting device having an accessory is provided. The lighting device includes a light engine having two or more operating modes; an accessory comprising at least one additional operable component having at least two operating modes; and a control unit configured to vary the operating modes of the lighting device in accordance with an activation signal received by the control unit. Receipt of the activation signal cycles the lighting device through each of the operating modes.

### CROSS-REFERENCE TO RELATED APPLICATION(S)

This application claims priority to U.S. Application No. 63/558,326, filed Feb. 27, 2024, the content of which is incorporated herein by reference in its entirety.

### BACKGROUND

Existing lighting devices being phased out in favor of more efficient and effective lighting devices, has led to an increased use of lighting devices with accessories containing one or more additional functions besides lighting alone. However currently, if a user wants to independently control the lighting and at least one additional operable component with a single switch, the user must hire an electrician to run a new set of wires and add an additional switch to the user's wall. Through applied effort, ingenuity, and innovation deficiencies of such lighting devices have been solved by developing solutions that are structured in accordance with the embodiments of the present invention, many examples of which are described in detail herein.

### BRIEF SUMMARY

According to an aspect of the present disclosure, a lighting device having an accessory is provided. In an example embodiment, the lighting device includes one or more light engines; an accessory having and/or including at least one additional operable component; and a control unit configured to operate the one or more light engines and the at least one additional operable component. The control unit is in communication with the one or more light engines and the at least one additional operable component and is configured to (i) receive an activation signal from a toggle switch, and (ii) cycle through a plurality of operating modes of the one or more light engines and the at least one additional operable component in response to receiving the activation signal. Each operating mode corresponds to a selective operation of at least one of (a) the one or more light engines or (b) the at least one additional operable component.

According to another aspect of the present disclosure, a lighting device having an accessory is provided. In an example embodiment, the lighting device includes one or more light engines; and an accessory having and/or including at least two additional operable components; and a control unit configured to operate the one or more light engines and the at least two additional operable components. The control unit is in communication with the one or more light engines and the at least two additional operable components and is configured to (i) receive an activation signal from a toggle switch, and (ii) cycle through one or more operating modes of one or more light engines and/or the at least two additional functional in response to receiving the activation signal. Each operating mode corresponds to a selective operation of at least one of (a) the one or more light engines or (b) the at least two additional operable components. The lighting device further includes a physical switch thereon configured to assist with operating the control unit. The physical switch enables user selection of at least a first setting and a second setting. The first setting is configured to enable the control unit to cycle through one or more operating modes in response to the activation signal and the second setting is configured to prevent the control unit from rotating through the one or more operating modes in response to the activation signal. A number of activations of the toggle switch and/or the control unit corresponds to a selection of either (a) on or (b) off for the one or more light engines, the at least two additional operable components, or both.

According to another aspect, a lighting device including an accessory is provided. In an example embodiment, the lighting device includes a light engine having three or more operating modes; an accessory comprising at least one additional operable component having at least two operating modes; and a control unit configured to vary the operating modes of the lighting device in accordance with an activation signal received by the control unit. Receipt of the activation signal cycles the lighting device through each of the operating modes.

According to another aspect, a lighting device including an accessory is provided. In an example embodiment, the lighting device includes a light engine having at least two operating modes; an accessory comprising at least one additional operable component having three or more operating modes; and a control unit configured to vary the operating modes of the lighting device in accordance with an activation signal received by the control unit. Receipt of the activation signal cycles the lighting device through each of the operating modes.

According to another aspect, a lighting device including an accessory is provided. In an example embodiment, the lighting device includes a light engine having two or more operating modes; an accessory comprising at least one additional operable component having at least two operating modes; and a control unit configured to vary the operating modes of the lighting device in accordance with an activation signal received by the control unit, wherein receipt of the activation signal cycles the lighting device through each of the operating modes.

### BRIEF DESCRIPTION OF THE SEVERAL VIEWS OF THE DRAWINGS(S)

Having thus described the disclosure in general terms, reference will now be made to the accompanying drawings, which are not necessarily drawn to scale, and wherein:

FIG. 1A illustrates a perspective view of an example lighting device in accordance with various embodiments of the present disclosure;

FIG. 1B illustrates an exemplary schematic cross-sectional view of an example lighting device in accordance with various embodiments of the present disclosure;

FIG. 1C provides a schematic wiring diagram of the example lighting device illustrated in FIG. 1B, in accordance with various embodiments;

FIG. 1D illustrates an exemplary schematic diagram of an example light engine in accordance with various embodiments of the present disclosure;

FIG. 1E illustrates an exemplary perspective view of an example fan in accordance with various embodiments of the present disclosure;

FIG. 2 illustrates an exemplary block diagram of at least some electrical components of a lighting device in accordance with various embodiments of the present disclosure;

FIG. 3 illustrates an exemplary block diagram of a remote switch in communication with a lighting device in accordance with various embodiments of the present disclosure;

FIG. 4 illustrates an exemplary block diagram of a computing entity that may be used as a remote switch in communication with a lighting device in accordance with various embodiments of the present disclosure;

FIG. 5 illustrates an exemplary illustrating processes and procedures of operating a lighting device in accordance with various embodiments of the present disclosure;

FIG. 6A illustrates an exemplary operation configuration of a lighting device in accordance with various embodiments of the present disclosure; and

FIG. 6B illustrates an exemplary operation configuration of a lighting device in accordance with various embodiments of the present disclosure.

### DETAILED DESCRIPTION OF VARIOUS EMBODIMENTS

The present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” “bottom,” etc. are used for explanatory purposes in the examples provided below to describe the relative positions of certain components or portions of components. As used herein, the term “or” is used in both the alternative and conjunctive sense, unless otherwise indicated. The term “along,” and similarly utilized terms, means near or on, but not necessarily requiring directly on an edge or other referenced location.

As used herein, terms “approximately,” “generally,” and “substantially” refer to within manufacturing and/or engineering design tolerances for the corresponding materials and/or elements unless otherwise indicated. The use of such terms is inclusive of and is intended to allow independent claiming of specific values listed. Thus, use of any such aforementioned terms, or similarly interchangeable terms, should not be taken to limit the spirit and scope of embodiments of the present disclosure. As used in the specification and the appended claims, the singular form of “a,” “an,” and “the” include plural references unless otherwise stated. The terms “includes” and/or “including,” when used in the specification, specify the presence of stated feature, elements, and/or components; it does not preclude the presence or addition of one or more other features, steps, operations, elements, components, and/or groups thereof.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment. As used herein, the terms “example,” “exemplary,” and the like are used to “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

Aspects of the present disclosure may be implemented as computer program products that comprises articles of manufacture. Such computer program products may include one or more software components including, for example, applications, software objects, methods, data structure, and/or the like. A software component may be coded in any of a variety of programming languages. An illustrative programming language may be a lower-level programming language such as an assembly language associated with a particular hardware architecture and/or operating platform/system.

Other examples of programming languages included, but are not limited to, a macro language, a shell or command language, a job control language, a script language, a database query, or search language, and/or report writing language. In one or more example embodiments, a software component comprising of instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or library. Software components may be static (e.g., pre-established, or fixed) or dynamic (e.g., created or modified at the time of execution).

In various embodiments, a lighting device may include integrated circuits configured to control operation of one or more operable components of the lighting device described herein. For example, the lighting device may include one or more integrated circuits, application specific integrated circuits (ASICs), field programmable gate arrays (FPGAs), programmable logic arrays (PLAs), and/or the like configured to cause the lighting device to cause operation of the lighting device in accordance with one or more operating modes.

Additionally, or alternatively, aspects of the present disclosure may be implemented as a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media may include all computer-readable media (including volatile and non-volatile media).

In one aspect, a non-volatile readable storage may include a floppy disk, flexible disk, hard disk, solid-state storage (SSS) (e.g., a solid-state drive (SSD), solid state card (SSC), solid state module (SSM), enterprise flash drive, magnetic tape, and/or the like. A non-volatile computer-readable storage medium may also include compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one aspect, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where aspects are described to use a computer-readable storage medium, other types of computer-readable storage media may be substituted for or used in addition to the computer-readable storage media described above.

Aspects of the present disclosure are described below with reference to block diagrams and flowchart illustrations. Thus, it should be understood that each block of the block diagrams and flowchart illustrations may be implemented in the form of a computer program product, a solely hardware aspect, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such aspects can produce specifically configured machines performing the steps or operations specified in the block diagrams and flowchart illustrations. Accordingly, the block diagrams and flowchart illustrations support various combinations of aspects for performing the specified instructions, operations, or steps.

As should be appreciated, various aspects of the present disclosure may also be implemented as methods, apparatuses, systems, computing devices, computing entities, and/or the like. As such, aspects of the present disclosure may take the form of a data structure, apparatus, system, computing device, computing entity, and/or the like executing instructions stored on a computer-readable storage medium to perform certain steps or operations. Thus, aspects of the present disclosure may also take the form of an entirely hardware aspect, an entirely computer program product aspect, and/or an aspect that comprises combination of computer program products and hardware performing certain steps or operations.

The figures are provided to illustrate some examples of the disclosure described. The figures are not to limit the scope of the present embodiment of the disclosure or the appended claims. Aspects of the example embodiment are described below with reference to example applications for illustration. It should be understood that specific details, relationships, and methods are set forth to provide a full understanding of the example embodiment. One of ordinary skill in the art recognize the example embodiment can be practice without one or more specific details and/or with other methods.

### General Overview

Example embodiments of the present disclosure provide a lighting device having one or more light engines and an accessory having and/or including at least one additional functional component (also referred to as an operable component herein). The lighting device is configured to have two or more selectable operating modes. For example, in an example embodiment, the lighting device accessory includes an additional operable component that is a fan (e.g., a ceiling fan or vent/exhaust fan). For this example lighting device, the two or more selectable operating modes of the lighting device may be: light on and fan on, light on and fan off, and light off and fan on. In certain embodiments, the two or more selectable operating modes may include different operating modes corresponding to an intensity of the light and/or a speed of the fan (e.g., light on bright and fan on high, light on dim and fan on low, light on bright and fan on low, light on dim and fan on high, and/or the like).

In various embodiments, switching between one or more of the operating modes causes the power to the one or more light engines and at least one additional operable component to be adjusted and/or modified. For example, the first activation of a toggle switch (e.g., a wall switch in wired and/or wireless communication with a control unit of the lighting device) may cause a control unit of the lighting device to turn on both the one or more light engines and the at least one additional operable component. For example, the second activation of the toggle switch may cause the control unit to maintain power to the one or more light engines and to stop providing power to the one or more additional operable components such that the one or more additional operable components are turned off. For example, the third activation of the toggle switch may cause the control unit to stop providing power to the one or more light engines such that the light engines are turned off and to provide power to the one or more additional operable components such that the one or more additional operable components are powered on.

In an example scenario, a lighting device is installed in a space such that a remote switch (e.g., a toggle/wall switch) configured to control flow of electrical power (e.g., in the form of line voltage) to the lighting device. When a user toggles the remote switch (e.g., turns the switch on, off, and back on or off and back on when the lighting device is already on) within a predetermined length of time, the lighting device is configured to cycle through a set of operating modes. In an example embodiment, the predetermined length of time is three seconds. For example, the lighting device may be configured to allow up to three seconds between toggles of the wall switch in order to change the operating mode. Once the lighting device has been operated for ten seconds in a specific operating mode, the lighting device may store the specific operating mode. For example, after the lighting device has been operated for at least ten seconds in the specific operating mode and then the remote switch is turned off, the next time the remote switch is turned on, the lighting device is operated in the specific operating mode.

In another example scenario, a lighting device may be installed in a space and a user may use a home automation app operating, at least in part, on a computing entity (e.g., the user's mobile phone, tablet, and/or the like). For example, the user may interact with the home automation app to provide user input regarding a desired operating mode and/or selecting an operating mode of the lighting device. The home automation app causes, via a local Wi-Fi network, a toggle switch to be controlled such that the home automation app causes the toggle switch to be cycled in accordance with the user's desired and/or selected operating mode

Example embodiments of the present disclosure described herein generally relate to a lighting device (e.g., light emitting diode (LED) lighting device) wherein the operating aspects or qualities (e.g., power, brightness, color temperature, color rendering index (CRI), and the like), are selectively configurable. In various embodiments, the operating aspects may refer to the adjustment of an AC or DC current provided to the one or more light engines and/or at least one additional operable component of the lighting devices, wherein the adjustment of AC or DC current may cause the light engines and/or at least one additional operable component to turn on or off. In some embodiments, the adjustment of AC or DC current may further cause a modification in the intensity of the operation of the light engines and/or at least one additional operable component. For example, a brightness level of light emitted by the one or more light engines may be modified and/or adjusted and/or a motor speed of the at least one additional operable component (e.g., in the example where the at least one additional operable component is a fan) may be increased/decreased or set at fixed speeds such as low, medium, and high. In various embodiments, the lighting device may be configured to provide light having a selectively configurable color temperature. For example, the one or more light engines may be further configured to be operated so as to emit light having a selectively configurable color temperature. However, it should be understood that principles of the present disclosure may be used to provide a lighting device for which the power selection of one or more light engines and/or at least one additional operable component may be modified through selection of a particular mode.

LEDs may be manufactured that emit light at a variety of color temperatures. Moreover, LEDs may be configured to emit light at a variety of brightness, CRI, and/or having other configurable light aspects or qualities. Embodiments of the present disclosure allow a user to take advantage of the variety of light aspects or qualities at which one or more light engines (e.g., LEDs) may emit light by allowing the user to operate a lighting device at a selectable mode such that the user may select and/or modify aspects or qualities of the emitted light. For example, embodiments of the present disclosure allow a user to take advantage of the variety of color temperatures at which LEDs may emit light by allowing the user to operate the lighting device (e.g., LED lighting device) at a selectable configurable operating color temperature. For example, the user may be able to change the operating color temperature of the lighting device as the user desires during the operation of the lighting device. The user may also choose to select a programmable operating color temperature for the lighting device. For example, the lighting device may be programmed to a set operating color temperature mode in which the operating color temperature cannot be changed during operation of the lighting device. Thus, embodiments of the present disclosure allow a user to take advantage of the wide range of color temperatures at which LEDs may produce light.

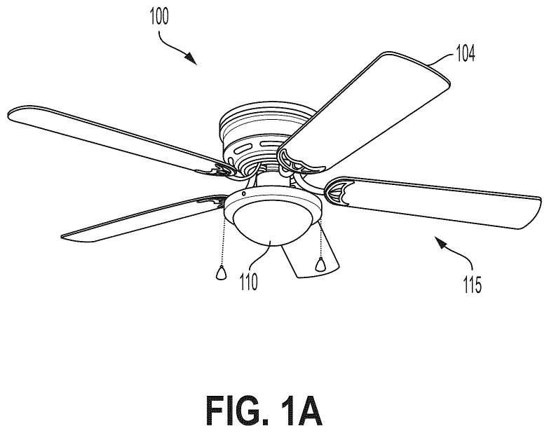

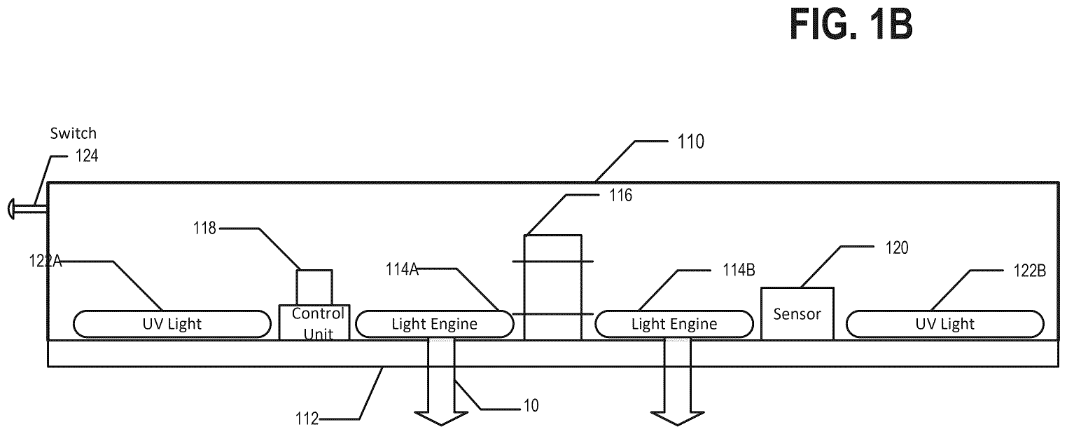

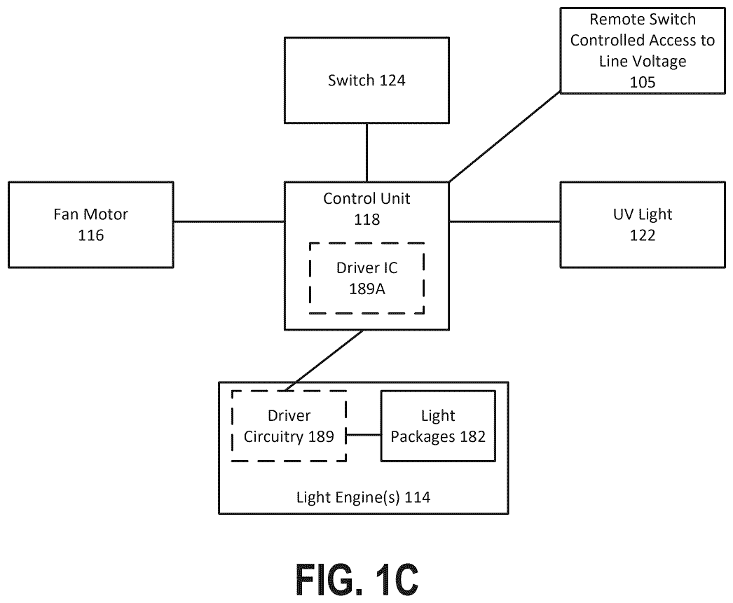

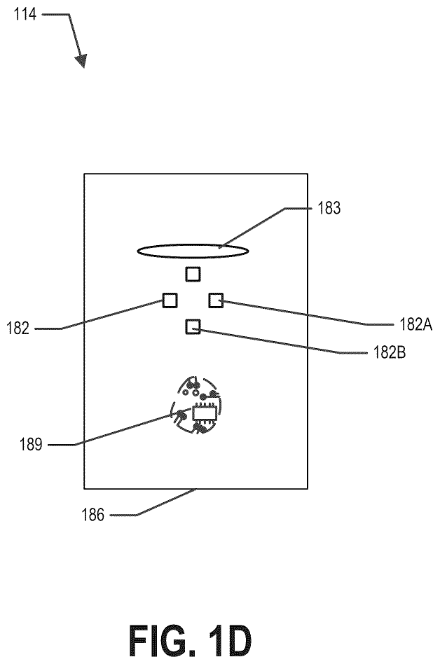

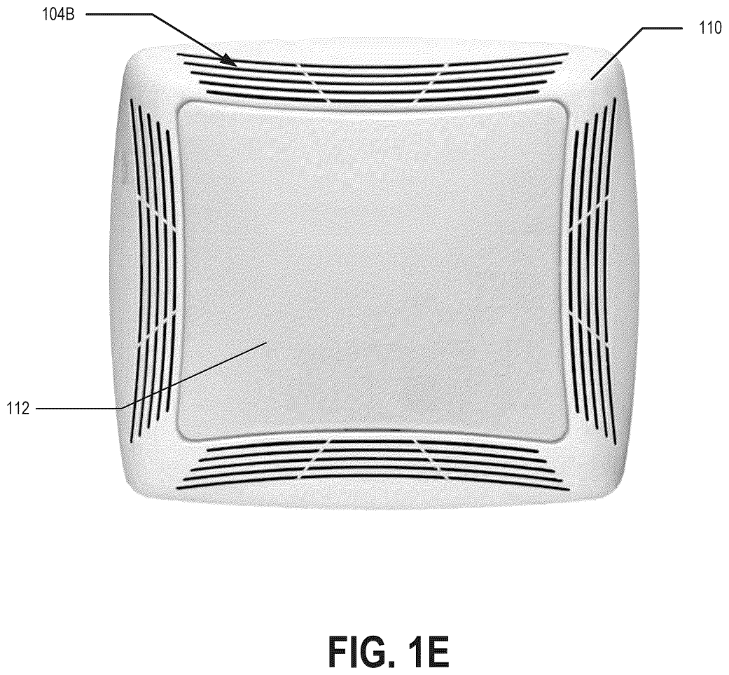

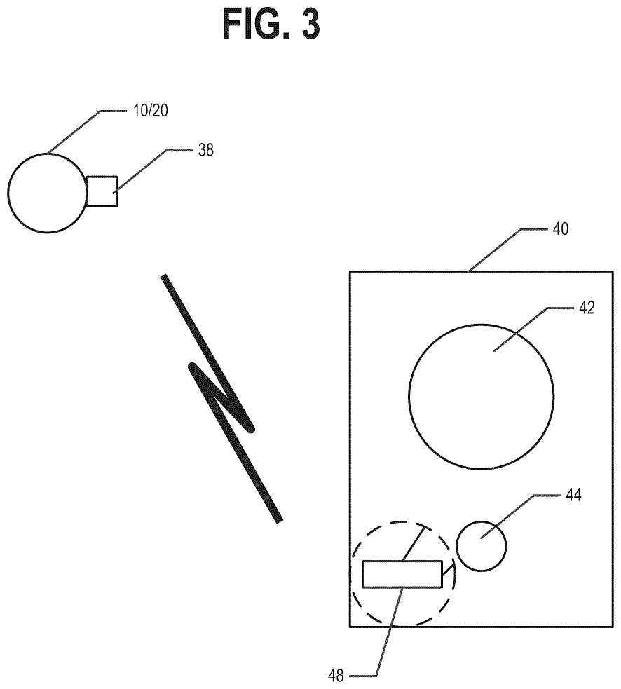

In an example embodiment, the lighting device 100 as depicted in FIG. 1A (e.g., LED lighting device) allows a user to select an operating mode (e.g., a programmable custom mode, a set mode, or a configurable mode). One or more qualities of the light (e.g., color temperature, brightness, CRI, and/or the like) emitted by the lighting device 100 and/or the one or more light engines 114 (e.g., 114A, 114B, see FIG. 1B) may then be controlled based on the user-selected operating mode. In various embodiments, the lighting device 100 controlling the power to the one or more light engines 114 and/or at least one additional operable component may be modified through mode switching (e.g., using switch 124 depicted in FIG. 1B) and/or configured using a remote switch 40 (see FIG. 3) when the user-selected mode is a configurable mode. In various embodiments, the lighting device 100 and/or the one or more light engines 114 may be further modified through power selection for the one or more light engines 114 and/or the one or more additional operable components (e.g., ceiling fan, vent fan, ultraviolet light (UV light), etc.).

In an example embodiment, the lighting device 100, the one or more light engines 114, and/or at least one additional operable component allows a user to select between one or more non-adjustment modes in which the user may select the power for each individual component and/or operating qualities of the light emitted by the lighting device 100, the one or more light engines 114, and/or at least one additional operable component (e.g., fan, UV light, etc.). In various embodiments, the non-adjustment mode(s) and/or sensor adjustment mode(s) may be set operating modes and/or configurable operating modes. In an example embodiment, the lighting device 100, the one or more light engines 114, and/or at least one additional operable component may be in communication with one or more sensors (e.g., light sensor, photocell, motion sensor), and, when the lighting device 100, the one or more light engines 114, and/or at least one additional operable component is in a sensor adjustment mode.

### Example Lighting Device

FIG. 1A provides an example perspective view of an example lighting device 100 in accordance with an example embodiment of the present disclosure. In various embodiments, the lighting device 100 includes one or more light engines and an accessory having and/or including one or more additional operable components. In an example embodiment, the example lighting device comprises at least one housing 110 configured to house the light engines of the lighting device 100. The example lighting device further includes at least one additional operable component 104 (e.g., ceiling fan, in the embodiment shown in FIG. 1A). FIG. 1B provides a schematic cross-sectional view of the at least one housing 110 of the lighting device, wherein the housing 110 may be configured to store one or more light engines 114A, 114B (collectively “114”), an additional operable component motor 116, at least one control unit 118, one or more sensor 120, one or more UV lights 122A, 122B (collectively “122”), and/or the like. FIG. 1B provides a schematic wiring diagram illustrating the electrical connections between various components of the lighting device 100 shown in FIG. 1B. In various embodiments, the housing 110 may comprise a covering 112 through which light 10 (generated by the one or more light engines 114). For example, the covering 112 may be configured to be at least partially transparent/opaque, such that light from the one or more light engines 114 and/or the one or more UV lights 122 are capable of passing through the cover.

In some embodiments, the housing 110 may further comprise a physical switch 124 configured to assist with operating the control unit 118. In various embodiments, the lighting device 100 is electrically powered via a connection to line voltage 105 that is controlled via a remote switch 40. For example, the remote switch 40 may be a wall switch configured to complete or interrupt an electrical circuit configured to provide line voltage to the control unit 118, for example, of the lighting device 100. In some embodiments, the physical switch 124 comprises two or more settings. The first setting may be configured to enable the control unit to cycle through one or more operating modes in response to the activation signal, and the second setting may be configured to prevent the control unit from rotating through the one or more operating modes in response to the activation signal. In some embodiments, a number of activations of the remote switch 40 (e.g., a toggle switch or wall switch) and/or the control unit 118 corresponds to a selection of either on or off for the one or more light engines 114, the at least one additional operable component (e.g., UV light 122, motor 116 for ceiling fan, or the like), or both.

FIG. 1D provides a schematic diagram of an example light engine 114 in accordance with an example embodiment of the present disclosure. In various embodiments, the one or more light engines 114 may include one or more lighting packages 182, 182A, 182B mounted to a circuit board 186 and, in some embodiments, driver circuitry 189 configured to condition voltage and/or current provided to the lighting packages 182, and/or the like. In certain embodiments, at least some components of the driver circuitry 189 are mounted to the circuit board 186. For example, the circuit board 186 may be a printed circuit board (PCB) and/or a circuit board configured to act as a heat sink. In some embodiments, a light engine 114 includes integrated primary and/or secondary optics 183. In certain embodiments, the light engine 114 further includes a heat sink, heat dissipation elements (e.g., fins, radiators, and/or the like), and/or other elements of the light engine.

In various embodiments, a light engine is hardwired into the lighting device 100. With further reference to FIG. 1D, in various embodiments, an example light engine 114 includes a light emitting diode (LED) module and/or LED package. For example, a lighting package 182 may be an LED package including one or more encapsulated LED chips. In an example embodiment, the one or more LED packages are mounted one or more circuit boards. For example, in an example embodiment, the LED package(s) and/or circuit board(s) to which the LED package(s) is mounted, is hardwired into the lighting device 100. In an example embodiment, a light engine 114 is an LED package including one or more LED chips; an enclosure enclosing the one or more LED chips (e.g., electrically and/or environmentally isolating the one or more LED chips from an external environment); electrical contacts (e.g., leads and/or traces on the one or more circuit boards); phosphor (e.g., in the case where the emitted light is white light); an encapsulant configured to protect the LED chips, wire bonds, and phosphor; and, optionally, an optical element configured to one or more light aspects or qualities (e.g., power, brightness, color temperature, CRI, and/or the like) and/or dispersion/focus of light emitted by the LED package. In an example embodiment, the light engine 114 includes one or more LED packages and may further include one or more additional optical elements, one or more heat sinks components, and/or electronic components (e.g., driver circuitry 189 and/or the like).

In an example embodiment where the one or more LED chips of respective light engines 114 are mounted to one or more circuit boards, components of the driver circuitry 189 may also be mounted to the one or more circuit boards.

In an example embodiment, a light engine is removably coupled (e.g., via socket) to the lighting device 100. For example, the light engine 114 may be a lamp (e.g., an LED lamp) that may be physically secured into a socket of a lighting device such that the light engine 114 is electrically connected to the lighting device 100. In certain embodiments, the light engine 114 may include a base that is the size of a traditional/standard incandescent lamp. For example, the base be sized according to an A15, A19, A21, A22, B8, B10, C7, C9, C11, C15, F10, F15, F20 and/or other traditional/standard lamp size. In various embodiments, the size of the light engine 114 may vary, as appropriate for the application.

FIG. 1E provides a perspective view of an example lighting device accessory with an additional operable component 104B (e.g., a ceiling vent fan) in accordance with an example embodiment of the present disclosure. In various embodiments, the additional operable component 104B is a vent fan that is configured to be operated by at least one motor 116. In various embodiments, the additional operable component (e.g., vent fan) may be configured to be housed within the housing 110 of the lighting device.

FIG. 1C provides a block wiring diagram of an example lighting device 100. The electrical components of the lighting device 100 may comprise a switch 124 in electrical communication with a control unit 118. The control unit 118 may be in electrical communication with the driver circuitry 189. In an example embodiment, the control unit 118 may be in electrical communication with a driver integrated circuit (IC) 189A configured to control, condition, configure and/or the like the electrical current provided to one or more lighting packages 182. The driver circuitry 189 may then provide the configurable electrical current to the one or more lighting packages 182, causing the lighting device to be operated according to the mode selected through the switch 124.

### Example Light Engines

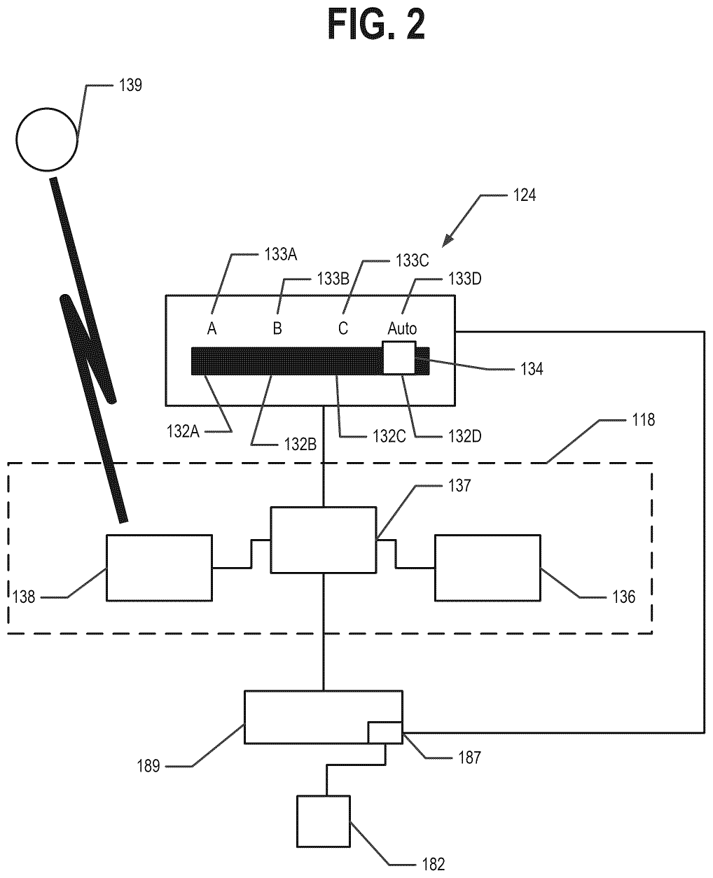

In example embodiments, the one or more light engines 114 and/or one or more additional operable components (e.g., UV light) may comprise one or more lighting packages 182. In an example embodiment, a lighting package 182 is a light emitting diode (LED) lighting package. In example embodiments, a lighting package 182 comprises one or more chips, electrical contacts, and optionally phosphor (e.g., to cause the lighting package to emit white light). The lighting package 182 may further comprise encapsulant to protect the one or more chips, wire bonds, and the phosphor. In an example embodiment, the lighting packages 182 may comprise one or more alternate current (AC) driven LEDs. In some embodiments, the lighting package 182 may further comprise one or more optical elements (e.g., integrated primary and/or secondary optics 183). In example embodiments, the one or more lighting packages 182 may comprise two or more lighting packages 182. In example embodiments, the two or more lighting packages may comprise at least one first lighting package 182A and at least one second lighting package 182B. The first lighting package 182A may be configured to emit light at a first color temperature and the second lighting package 182B may be configured to emit light at a second color temperature. The second color temperature may be different from the first color temperature. For example, the first color temperature may be 3000K or 2700K and the second color temperature may be 5000K. In further embodiments, a combination of lighting packages 182A and 182B provide a third color temperature (e.g., an intermediate color temperature between the first color temperature and the second color temperature). In example embodiments, the two or more lighting packages 182 may further comprise a third and/or fourth lighting package configured to emit light at a third and/or fourth color temperature, respectively, wherein the third and/or fourth color temperature are different from the first and second color temperatures. For example, in various embodiments, one or more of the lighting packages 182 may be configured to emit light of at least one of 2700K, 3000K, 3500K, 4000K, 5000K, 5700K, 6000K, 7000K, 7500K and/or other color temperatures, as appropriate for the application. For example, as shown in FIG. 2, the lighting device may be configured to selectively provide light of color temperature A 132A, B 132B, or C 132C, wherein A, B, and C may be any preset color temperature provided each is different relative to one another.

In example embodiments, the two or more lighting packages 182 may be in electrical communication with driver circuitry 189 such that the two or more lighting packages 182 may be operated by the driver circuitry 189. For example, the driver circuitry 189 may provide a controlled electrical current to at least one of the lighting packages 182. For example, the driver circuitry 189 may be configured to only operate first lighting packages 182A to cause the light engine to emit light of the first color temperature. In another example, the driver circuitry 189 may be configured to only operate second lighting packages 182B to cause the light engine to emit light of the second color temperature. In another example, the driver circuitry 189 may be configured to operate one or more (e.g., half) of the first lighting packages 182A and one or more (e.g., half) of the second lighting packages 182B to cause the light engine to emit light of a third color temperature. In example embodiments, the first color temperature, second color temperature, and third color temperature may be different from one another. For example, the first color temperature may be 3000K, the second color temperature may be 5000K, and the third color temperature may be 4000K. In some embodiments, the light engine may comprise lighting packages 182 configured to emit light at more than two distinct color temperatures (e.g., three, four, or more distinct color temperatures.

In example embodiments, the one or more lighting packages 182 may be configured to provide light that varies in brightness, color temperature, CRI, and/or the like based on the current provided to the one or more lighting packages 182 by the driver circuitry 189. For example, the driver circuitry 189 may provide a particular current to a lighting package 182 to cause the lighting package 182 to provide light having particular light aspects or qualities.

In example embodiments, the lighting packages 182 may comprise one or more lighting packages 182 that are configured to emit light other than “white” light. For example, the lighting packages 182 may comprise one or more lighting packages 182 configured to emit a red or amber light that may be operated to increase the CRI of the light emitted by the light engine.

### Example Driver Circuitry

In example embodiments, the driver circuitry 189 may be configured to provide a controlled electrical current to at least one of the lighting packages 182 during operation of at least one light engine of the lighting device. In various embodiments, the driver circuitry 189 may comprise a circuit portion configured to convert AC voltage into DC voltage. In some embodiments, the driver circuitry 189 may comprise a circuit portion configured to control the current flowing through the two or more lighting packages 182. In certain embodiments, the driver circuitry 189 may comprise a circuit portion configured to dim the one or more light engines of the lighting device. In various embodiments, additional circuit components may be present in the driver circuitry 189. Similarly, in various embodiments, all or some of the circuit portions mentioned here may not be present in the driver circuitry 189. In some embodiments, circuit portions listed herein as separate circuit portions may be combined into one circuit portion. As should be appreciated, a variety of driver circuitry configurations are generally known and understood in the art and any of such may be employed in various embodiments as suitable for the intended application, without departing from the scope of the present disclosure.

In example embodiments, the driver circuitry 189 may be configured to operate subsets of the two or more lighting packages 182 at a particular given moment in time. For example, if a first color temperature has been selected by a user as the operating color temperature, the driver circuitry 189 may be configured to operate one or more first lighting packages 182A configured to emit light at the selected first color temperature. If a second color temperature has been selected by the user as the operating color temperature, the driver circuitry 189 may be configured to operate one or more second lighting packages 182B configured to emit light at the second selected color temperature. If a third color temperature has been selected by the user as the operating color temperature, the driver circuitry 189 may be configured to operate at least a portion of the first lighting packages 182A (e.g., half of the first lighting packages 182A) and at least a portion of the second lighting packages 182B (e.g., half of the second lighting packages 182B) to provide (e.g., via a combination of the first and second lighting packages) a selected third color temperature that is a composite, mixture, or superposition of the first and second color temperatures. The selection of which lighting packages 182 are operated by the driver circuitry 189, when the lighting device 100 is operated, is determined by the status of the switch 124 and/or by the control unit 118. For example, the driver circuitry 189 may comprise a plurality of provider circuits 187 configured to provide a controlled electrical current to a subset of the two or more lighting packages 182 depending on the selected operating color temperature and/or the status of the switch 124.

In another example, the driver circuitry 189 may be configured to provide a particular current to one or more of the lighting packages 182 to provide light having specific light aspects qualities (e.g., brightness, color temperature, CRI, and/or the like). For example, the driver circuitry 189 may be configured to drive one or more lighting packages 182 such that the lighting packages provide light having the desired light aspects or qualities. The determination of how one or more of the lighting packages 182 should be driven (e.g., what current should be supplied to the lighting packages 182) may be determined by the status of the switch 123 and/or by the control unit 118. Based on the desired light aspects or qualities, different lighting packages 182 may be driven differently. For example, “white” lighting packages 182 may be driven differently from a red or amber lighting package 182 that is being operated to increase the CRI of the light emitted by the one or more light engines of the lighting device. Thus, the provider circuits 187 may be configured to provide various lighting packages 182 with a particular configurable current such that the composite light emitted by the one or more light engines of the lighting device has the user desired light aspects or qualities.

In example embodiments, various configurations of provider circuits 187 may be applied. For example, as noted above, a provider circuit 187 may be configured to provide electrical current to only the first lighting packages 182A, only the second lighting packages 182B, or a predetermined combination of the first and second lighting packages 182A and 182B. For example, a provider circuit 187 may be configured to provide electrical current to half of the first lighting packages 182A and half of the second lighting packages 182B to provide light of the third color temperature. In another example, a provider circuit 187 may be configured to provide electrical current to 25% of the first lighting packages 182A and 75% of the second lighting packages 182B to provide light of a fourth color temperature. It should be understood that a provider circuit 187 may be configured to provide controlled electrical current to various combinations of the first lighting packages 182A and the second lighting packages 182B to provide various color temperature options. Furthermore, in example embodiments, the two or more lighting packages 182 may comprise three or more lighting packages 182. For example, the lighting packages 182 may comprise at least one first lighting package 182A configured to emit light at a first color temperature, at least one second lighting package 182B configured to emit light at a second color temperature, and at least one third lighting package configured to emit light at a third color temperature, the first, second, and third color temperatures being different from one another. In such an embodiment, a provider circuit 187 may be configured to provide electrical current to at least one of the first lighting packages 182A, at least one of the second lighting packages 182B, and at least one of the third lighting packages to provide a three color blend. It should be understood that lighting packages configured to emit light at additional color temperatures may be incorporated into the lighting device 100 as desired and/or appropriate for the application and that various combinations of the lighting packages may be activated to cause the lighting device 100 to emit light of a desired operating color temperature.

As noted above, the light aspects or qualities (e.g., brightness, color temperature, CRI, and/or the like) may be controlled by how the one or more lighting packages 18 are operated (instead of and/or in addition to which of the lighting packages 18 are operated). In example embodiments, one or more configurable qualities of the light emitted by the lighting device 100 may configured by controlling the current provided to one or more of the lighting packages 182. In particular, the driver circuitry 189 may drive the one or more lighting packages 18 with a higher or lower current to modify the brightness, color temperature, CRI, and/or the like of the light emitted by the one or more lighting packages 18. In another example, the driver circuitry 189 may increase or decrease the number of lighting packages 182 being driven to increase or decrease the brightness of the light emitted by the lighting device 100. In another example, one or more red or amber lighting packages 182 may be turned on (e.g., electrical current may be supplied thereto by the driver circuitry 189) to increase the CRI of the light emitted by the lighting device 100.

In another example, the integrated primary or secondary optics 183 are used to condition the light emitted by the lighting device 100. For example, integrated primary optics that are part of the lighting packages 182 may be used to provide light having various qualities. For example, the integrated primary optics may be chromatic or spatial filters, lenses, dispersion elements, and/or the like that are integrated as part of a lighting package 182. In another example, secondary optics may be positioned to condition light emitted by the lighting packages 182. For example, the secondary optics may be chromatic or spatial filters, lenses, dispersion elements, and/or the like configured for conditioning light that has been emitted by the light packages. In some embodiments, the optics 183 are configurable. For example, the optics 183 may be modified by applying a current to the optics (e.g., an optical component that has optical properties that change based on an electric field experienced by the optical component), physical movement of the optics into and/or out of the light path of light emitted by the lighting package 182, and/or the like.

Thus, in example embodiments, one or more qualities of the light emitted by the lighting device 100 may be modified, controlled, configured, and/or the like by changing and/or controlling the amount of current provided to one or more lighting packages 18, which lighting packages 182 of the two or more lighting packages 182 are being operated, physically changing the primary and/or secondary optics 183 conditioning the light, and/or the like. Thus, for example in an embodiment configured to provide configurable brightness settings or modes, the dimming of the lighting device 100 may be controlled by the control unit 118 and/or driver circuitry 189 rather than by the externally provided current.

In example embodiments, when the lighting device 100 is in a configurable operating mode, interaction with the remote switch 40 (e.g., reception of a signal from the remote switch 40) may cause the topology of the driver circuitry to be altered. For example, user interaction with the remote switch 40 may cause a signal to be provided to the control unit 118. The control unit 118 may then cause a change in the topology of the driver circuitry 189, thereby causing the driver circuitry 189 to operate a different set of lighting packages 182, drive one or more lighting packages 182 with a modified current, and/or the like.

In another example embodiment, the operating mode is a state stored in a memory of the control unit 118 (e.g., memory element 136) or a state machine. For example, as shown in FIG. 2, the control unit 118 includes one or more processing elements 137, one or more memory elements 136, and/or one or more communication interface elements 138. In an example embodiment, the control unit 118 receives user input indicating user interaction with a computing entity 50 via a communication interface element 137. For example, the communication interface element 137 may be configured to communicate via Wi-Fi such that the communication interface element 137 receives an indication of user interaction with the computing entity 50 via a Wi-Fi signal, local Wi-Fi network, and/or the like. The processing element 137 may process the received indication of user interaction and determine an operating mode based at least in part thereon. The processing element 137 may then cause the memory element 136 and/or a state machine to be updated to indicate the current operating mode of the lighting device 100.

### Example Switch

In example embodiments, the lighting device 100 comprises a switch 124. In example embodiments, the switch 124 may be used to allow a user to select an operating mode (e.g., a programmable custom mode, a set mode, or a configurable mode). In various embodiments, the switch 124 may allow a user to control the power distributed to one or more light engines 114 and/or at least one additional operable component (e.g., fan motor, UV light, vent fan, etc.), wherein the power selection may then be controlled based on the user-selected operating mode. In some embodiments, the switch 124 may be further configured to allow a user to adjust one or more aspects or qualities of the light (e.g., color temperature, brightness, CRI, and/or the like) emitted by the lighting device 100, one or more light engines 114, and/or one or more UV lights 122, wherein the aspects or qualities may then be controlled based on the user-selected operating mode. In example embodiments, the switch 30 may be a mechanical switch, electro-mechanical switch, a relay, a switch controlled by an infrared sensor, and/or the like. For example, if the switch 124 is a mechanical switch, the switch 124 may comprise a slide switch, a dial, a set of binary switches, jumpers, and/or the like. In an example embodiment, the switch 124, and/or a user interface thereof, may be disposed on an exterior surface of the housing 110. FIG. 2 provides a block diagram of at least some of the electrical components of a lighting device 100, one or more light engines 114 and/or one or more additional operable components, including a switch 124 and a control unit 118, in accordance with example embodiments of the present disclosure. In example embodiments, the switch 124 may comprise a plurality of switch positions 132 (e.g., 132A, 132B, 132C, 132D), switch position indicators 133 (e.g., 133A, 133B, 133C, 133D), and a switch selector 134. For example, the switch 124 may comprise four switch positions 132A, 132B, 132C, 132D, in example embodiments. In other embodiments, the switch 124 may comprise more than four switch positions 132 (e.g., 132A, 132B, 132C, 132D). For example, in various embodiments, the switch 124 may comprise two, three, four, five, six, seven, eight, or more switch positions with each switch position corresponding to either a set operating mode, a selectively configurable operating mode, or a programmable custom operating mode. One of the switch positions may correspond to a configurable operating mode (e.g., a configurable power selection mode, a configurable operating color temperature mode, configurable brightness mode, configurable brightness-color temperature mode, etc.) and the remaining switch positions may correspond to set operating modes (e.g., set power selection mode, set operating color temperature modes, set brightness modes, set operating brightness-color temperature modes, etc.).

In some embodiments, the switch 124 may provide the user with one or more programmable custom operating modes. In an example embodiment, the switch 124 may comprise a custom set operating the power selection for the one or more light engines and/or at least one additional operable component such that the one or more light engines and/or the at least one additional operable component cycle through a plurality of power modes. In another example, the switch 124 may comprise a custom program operating mode wherein the control unit 118 is configured to cause the operating color temperature, brightness, and/or CRI to change at configurable times (e.g., clock time) or at configurable periods of time.

In another example, a user may want the one or more light engines 114 and/or at least one additional operable component (e.g., UV light 122, fan motor 116, etc.) to operate for a predetermined amount of time and then to turn off power to the one or more light engines and/or at least one additional operable component (e.g., UV light 122, fan motor 116, etc.) after the predetermined amount of time has elapsed. In example embodiments having programmable custom operating mode options, additional user interface components (e.g., in addition to the switch 124) may be provided for the programming of the programmable custom operating mode. The additional user interface components may be located on the housing 110 of the lighting device and/or on a remote switch 40 (e.g., through a mobile computing entity 50 user interface, wherein the computing entity 50 is executing an application causing the computing entity 50 to operate as a remote switch 40). In example embodiments, such additional user interface components may comprise various switches, dials, displays, touchscreen displays, buttons, knobs, and/or the like.

A switch position indicator 133 (e.g., 133A, 133B, 133C, 133D) may correspond to each switch position 132 (e.g., 132A, 132B, 132C, 132D). The switch position indicator 133 (e.g., 133A, 133B, 133C, 133D) may be configured to indicate the power selection for the light engines 114 and/or at least one additional operable component. In an example embodiment, a user-selection switch 124 (e.g., a toggle switch, button, and/or the like) may be disposed on the lighting device 100 such that user-selection may be received through the physical switch 124 at the lighting device 100.

### Example Control Unit

In example embodiments, the lighting device 100 may comprise a control unit 118. In example embodiments, the control unit 118 may be configured to cause the driver circuitry 189 to operate one or more lighting packages 182 of the light engines and/or at least one additional operable component in accordance with the user-selected operating mode (e.g., a programmable custom mode, a set mode, or a configurable mode). In example embodiments, the control unit 118 may be a microcontroller unit (MCU). For example, the control unit 118 may comprise a single integrated circuit. In example embodiments, the control unit 118 comprises one or more processing elements 137, one or more memory elements 136, and/or one or more communication interface elements 138. In example embodiments, the control unit 118 may be in wired (e.g., hard-wired) communication with the switch 124 and/or configured to receive signals from the remote switch 40. In example embodiments, the control unit 118 may be configured to cause power selection of one or more light engines and/or at least one additional operable component of the lighting device 100 to be modified based on a received signal from the remote switch 40, store information/data identifying the last power selection at which the light engine or the lighting device 100 was operated at, and/or the like. For example, the control unit 118 may be configured to receive user selection of a programmable custom operating mode and control the light engine(s) 114 and/or at least one additional operable component of the lighting device 100 to operate in accordance with the programmable custom operating mode or other user-selected operating mode (e.g., set operating mode or configurable operating mode).

In example embodiments, the one or more processing elements 137 (also referred to as processors, processing circuitry, processing device, and/or similar terms used herein interchangeably) that communicate with other elements within the control unit 118. For example, the processing element(s) 137 may communicate with the memory element(s) 136, communication interface element(s) 138, and/or components of the driver circuitry 189 via direct electrical connection, a bus, and/or the like. For example, the processing element(s) 137 may be configured to process input received through the switch 124 (and/or additional user interface components), process a signal received from the remote switch 40 (e.g., through the communication interface element 138 and/or via the remote switch 40 controlling whether line voltage is provided to the lighting device 100 and/or control unit 118), cause the memory element 136 to store a current power selection, cause one provider circuit 187 to be activated (e.g., to provide a controlled electric current to the corresponding at least one lighting package 182 and/or at least one additional operable component), cause another provider circuit 187 to be de-activated (e.g., to stop providing an electric current to the corresponding at least one lighting package 182 of the light engines and/or at least one additional operable component), cause a different and/or modified current to be provided to the provider circuit 187 and/or the like. As will be understood, the processing element 137 may be embodied in a number of different ways. For example, the processing element 137 may be embodied as one or more complex programmable logic devices (CPLDs), microprocessors, multi-core processors, co-processing entities, application-specific instruction-set processors (ASIPs), microcontrollers, and/or controllers. Further, the processing element 137 may be embodied as one or more other processing devices or circuitry. The term circuitry may refer to an entirely hardware embodiment or a combination of hardware and computer program products. Thus, the processing element 137 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 137 may be configured for a particular use or configured to execute instructions stored in volatile or non-volatile media or otherwise accessible to the processing element 137. As such, whether configured by hardware or computer program products, or by a combination thereof, the processing element 137 may be capable of performing steps or operations according to embodiments of the present disclosure when configured accordingly.

The memory element(s) 136 may be non-transitory and may include, for example, one or more volatile and/or non-volatile memories. In other words, for example, the memory element 136 may be an electronic storage device (e.g., a computer readable storage medium) comprising gates configured to store data (e.g., bits) that may be retrievable by a machine (e.g., a computing device like the processing element 137). The memory element 136 may be configured to store information, data, content, applications, instructions, or the like for enabling the control unit 118 to carry out various functions in accordance with an example embodiment of the present disclosure. For example, the memory element 136 could be configured to buffer input data for processing by the processing element 137 (e.g., a signal received from the remote switch 40). Additionally or alternatively, the memory element 136 could be configured to store instructions for execution by the processing element 137.

As indicated, in one embodiment, the control unit 118 may also include one or more communications interface elements 138 for communicating with the remote switch 40 and/or a computing entity 50. For example, the communications interface element 138 may be configured to receive a signal from the remote switch 40 indicating user selection of, activation of, and/or interaction with an on/off or power button, a dimmer switch, or a remote selector switch configured to select or modify the current distributed to one or more light engines 114 and/or at least one additional operable component of the lighting device 100, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the communications interface element 138 may be configured to communicate via a wireless communication technology, such as a short-range communication technology. For example, the communications interface element 138 may be configured to receive and/or send signals using IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

In example embodiments, the control unit 118 may be configured to control the current selection (e.g., turn on or turn off) the one or more light engines 114 and/or at least one additional operable components (e.g., UV light, ceiling fan, fan motor, vent fan, etc.) of the lighting device 100. For example, the control unit 118 may be configured to determine the current power selection for the one or more light engines 114 and/or at least one additional operable components accordingly. For example, the control unit 118 may be configured to determine if the position of the switch selector 134 is a position corresponding to a set operating mode, to the position corresponding to the configurable operating mode, and/or to a position corresponding to a programmable custom operating mode. If the switch selector 134 is in a switch position 132 (e.g., 132A, 132B, 132C) corresponding to a set operating mode, the control unit 118 (e.g., the processing element 137) may determine the power cycle for the one or more light engines and/or at least one additional operable component (e.g., first cycle power on for both light engines and a first additional operable component, a second cycle power on for the one or more light engines and power off for the first additional operable component, and/or a third cycle power off for the one or more light engines and power on for the first additional operable component).

In various embodiments, the control unit 118 is in communication with one or more sensors 139. For example, the control unit 118 may communicate with one or more sensors via the communications interface element 138. In an example embodiment, the control unit 118 communicates with the one or more sensors wirelessly. In an example embodiment, the control unit 118 is in wired communication with the one or more sensors. In an example embodiment, the light engine 114 and/or at least one additional operable component of the lighting device 100 may comprise one or more sensors 139. In various embodiments, the one or more sensors 139 may comprise light sensors, photocells, motion sensors, noise sensors, and/or the like. In an example embodiment, the processing element 137 is configured to receive signals from one or more sensors 139 (e.g., via the communications interface element 138) and causes the operation of the light engine 114 and/or at least one additional operable component (e.g., fan, UV light, etc.) of the lighting device 100 to be adjusted, modified, or the like based on the received signals (e.g., turn power on or turn power off for the light engines and/or at least one additional operable components). In an example embodiment, the processing element 137 only adjusts, modifies, or the like the operation of the light engine 114 and/or at least one additional operable component (e.g., fan, UV light, etc.) of the lighting device 100 based on signals received from one or more sensors 39 when the status of the switch 124 corresponds to a configurable operating mode. In an example embodiment, the processing element 137 adjusts, modifies, or the like the current distributed to the light engines 114 and/or at least one additional operable component (e.g., fan, UV light, etc.) of the lighting device 100 based signals received from the one or more sensors 139 when the status of the switch 124 corresponds to a set operating mode such that the power current to the one or more light engines 114 and/or the at least one additional operable component (e.g., UV light, ceiling fan, vent fan etc.) is configured to be powered off in response to one or more signals received from the sensor.

### Example Remote Switch

Example embodiments of the present disclosure comprise a remote switch 40. In certain embodiments, a remote switch 40 may be a wall mounted switch mounted in the same room as the light engine 114 and/or at least one additional operable component (e.g., fan, UV light, etc.) of the lighting device 100 and/or within a short-range communication technology range of the light engine 114 and/or at least one additional operable component (e.g., fan, UV light, etc.) of the lighting device 100. For example, the remote switch 40 may be a wall and/or junction box mounted toggle switch, dimmer switch, and/or the like in wired communication with the control unit 118. For example, the remote switch 40 may have two positions such that when the remote switch 40 is in a first position, line voltage is provided to the lighting device 100 and when the remote switch 40 is in a second position, line voltage is not provided to the lighting device 100. In certain embodiments, the remote switch 40 is configured to communicate with the control unit 118 by providing pulses of line access to line voltage and/or periods (e.g., longer than a predetermined length of time) of access being provided to the line voltage or access being not provided to the line voltage. For example, in some embodiments, the control unit 118 determines an operating mode of the lighting device 100 based on a number of pulses of line voltage the control unit 118 receives during the set interval time.

In another example, the remote switch 40 may be a handheld device (e.g., a remote control, or computing entity 50) that is within the same room as the light engine 114 and/or at least one additional operable component (e.g., fan, UV light, etc.) of the lighting device 100, within a short-range communication technology range of the light engine 114 and/or at least one additional operable component (e.g., fan, UV light, etc.) of the lighting device 100, in communication with the control unit 118 through a wireless network (e.g., a local Wi-Fi network), and/or the like.

In example embodiments, the remote switch 40 may be in wired or wireless communication with the control unit 118. For example, the remote switch 40 may be configured to control the power selection of the light engine 114 and/or at least one additional operable component (e.g., fan, UV light, etc.) of the lighting device 100 or aspects thereof by providing a signal to the control unit 118 indicating user selection, interaction, and/or the like with one or more interactive elements of the remote switch 40. For example, the remote switch 40 may be configured to allow a user to toggle or cycle through one or more power selections of the one or more light engines 114 and/or at least one additional operable component (e.g., fan, UV light, etc.) of the lighting device 100. In example embodiments, the toggling of the remote switch 40 to change or modify the power selection could be at any time interval. In some embodiments, the remote switch 40 may be configured to complete a plurality of toggles to adjust/change the power light engine 114 and/or at least one additional operable component (e.g., fan, UV light, etc.) of the lighting device 100, wherein the toggles must be completed before the elapsing of a predetermined amount of time resets the toggles.

For example, the remote switch 40 may be configured to cause the light engine 114 and/or at least one additional operable component (e.g., fan, UV light, etc.) of the lighting device 100 to turn on or off, control the brightness of the lighting device 100 (e.g., through a dimmer switch), change the operating light aspects or qualities of the lighting device 100, program a programmable custom operating mode, and/or the like. An example remote switch 40 is illustrated in FIG. 3. In example embodiments, the remote switch 40 comprises one or more interactive elements (e.g., 42, 44). For example, the remote switch 40 includes an interactive element 42 that is an on/off and/or dimmer switch configured to turn on/off light engine 114 and/or at least one additional operable component (e.g., fan, UV light, etc.) of the lighting device 100. The remote switch 40 may comprise a remote selector 44 (e.g., a color temperature control) configured for remotely selecting an operating color temperature of the lighting device 100 when the lighting device 100 is in the configurable operating mode. In example embodiments, the remote selector 44 may be a slide, push button, rotary, passive infrared, and/or other type of interactive element that the user may interact with, select, press, touch, voice activate, and/or the like. Thus, the remote selector 44 may be configured to allow a user to select a desired operating color temperature, brightness, CRI, and/or other operating aspects or qualities, of the light engine 114 and/or at least one additional operable component (e.g., fan, UV light, etc.) of the lighting device 100. In example embodiments, the remote switch 40 may comprise additional user interface components as appropriate for the application.

In certain embodiments, the remote switch 40 further comprises a communication interface 48. In example embodiments, the communication interface 48 may be a part of a control unit that is similar to the control unit 118 (e.g., the control unit may comprise a processing element and/or memory element in addition to the communication interface 48). In example embodiments, the communication interface 48 is configured to provide a signal to the communication interface element 38 indicating user selection and/or interaction with the interactive element 42 (e.g., an on/off and/or dimmer switch), the remote selector 44, and/or the like.

For example, the communication interface 48 may be configured to communicate with the control unit 118. For example, the communication interface 48 may be configured to provide a signal to the communications interface element 138 indicating user selection of, activation of, and/or interaction with an interactive element 42 (e.g., an on/off and/or dimmer switch), remote selector 44, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the communication interface 48 may be configured to communicate via a wireless communication technology, such as a short-range communication technology. For example, the communication interface 48 may be configured to receive and/or send signals using IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### Example Computing Device Used as a Remote Switch

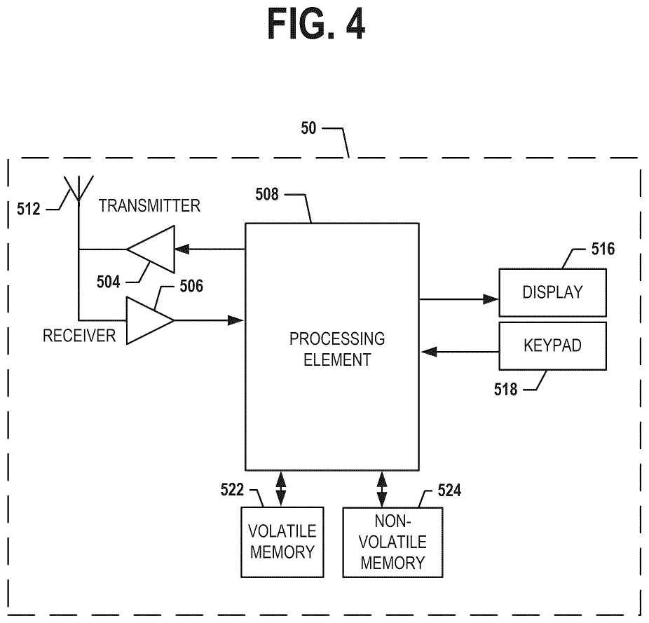

FIG. 4 provides an illustrative schematic representative of a computing entity 50 that can be used in conjunction with embodiments of the present disclosure. In particular, the computing entity 50 may be configured to operate and/or execute an application configured to cause the computing entity 50 to act as a remote switch 40. For example, the computing entity 50 may operate and/or execute an application configured to communicate with the control unit 118 and/or cause one or more aspects (e.g., current distributed to the one or more light engines and/or at least one additional operable components, brightness of one or more light engines and/or UV light, color of one or more light engine, etc.) to change for the light engine 114 and/or at least one additional operable component (e.g., fan, UV light, etc.) of the lighting device 100. In example embodiments, the computing entity 50 may be a mobile computing entity such as a mobile phone, tablet, phablet, wearable computing device, personal digital assistant (PDA), MP3 player, and/or the like. In an example embodiment, the remote switch 40 may be a building control system (e.g., a digital addressable lighting interface (DALI)-based building control system).

As shown in FIG. 4, a computing entity 50 can include an antenna 512, a transmitter 504 (e.g., radio), a receiver 506 (e.g., radio), and a processing element 508 that provides signals to and receives signals from the transmitter 504 and receiver 506, respectively. The signals provided to and received from the transmitter 504 and the receiver 506, respectively, may include signaling information/data in accordance with an air interface standard of applicable wireless systems to communicate with various entities, such as control unit 35, another computing entity 50, and/or the like. In this regard, the computing entity 50 may be capable of operating with one or more air interface standards, communication protocols, modulation types, and access types. More particularly, the computing entity 50 may operate in accordance with any of a number of wireless communication standards and protocols. In a particular embodiment, the computing entity 50 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the computing entity 50 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 50 can also download changes, add-ons, and updates, for instance, to its firmware, software (e.g., including executable instructions, applications, program modules), and operating system.

According to one embodiment, the computing entity 50 may include location determining aspects, devices, modules, functionalities, and/or similar words used herein interchangeably. For example, the computing entity 50 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the computing entity's 50 position in connection with a variety of other systems, including cellular towers, Wi-Fi access points, and/or the like. Similarly, the computing entity 50 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The computing entity 50 may also comprise a user interface (that can include a display 516 coupled to a processing element 508) and/or a user input interface (coupled to a processing element 508). For example, the user interface may be an application, browser, user interface, dashboard, webpage, and/or similar words used herein interchangeably executing on and/or accessible via the computing entity 50 to interact with and/or cause display of information. The user input interface can comprise any of a number of devices allowing the computing entity 50 to receive data, such as a keypad 518 (hard or soft), a touch display, voice/speech or motion interfaces, scanners, readers, or other input device. In embodiments including a keypad 518, the keypad 518 can include (or cause display of) the conventional numeric (0-9) and related keys (#, *), and other keys used for operating the computing entity 50 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 50 can collect contextual information/data as part of the telematics data.

The computing entity 50 can also include volatile storage or memory 522 and/or non-volatile storage or memory 524, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 50.

### Example Method of Operating a Lighting Device

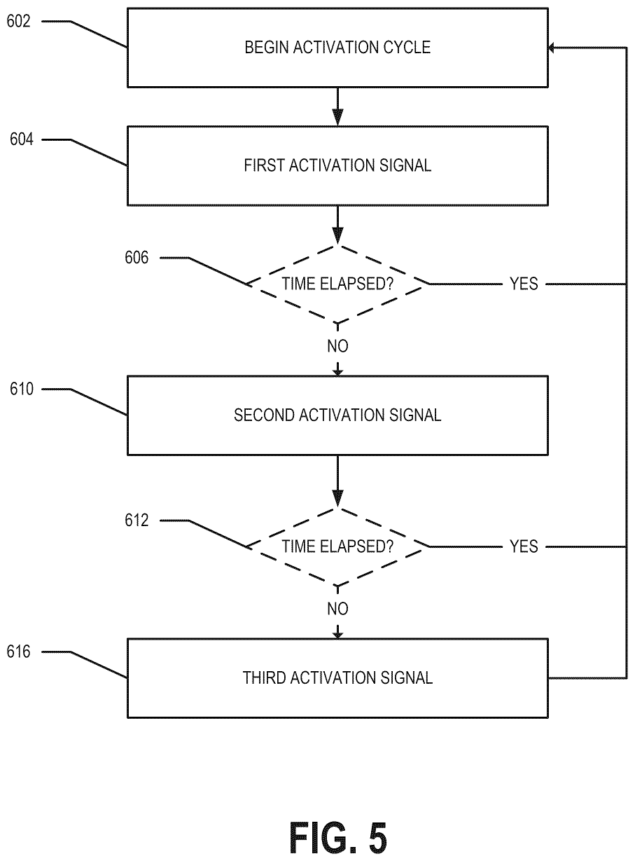

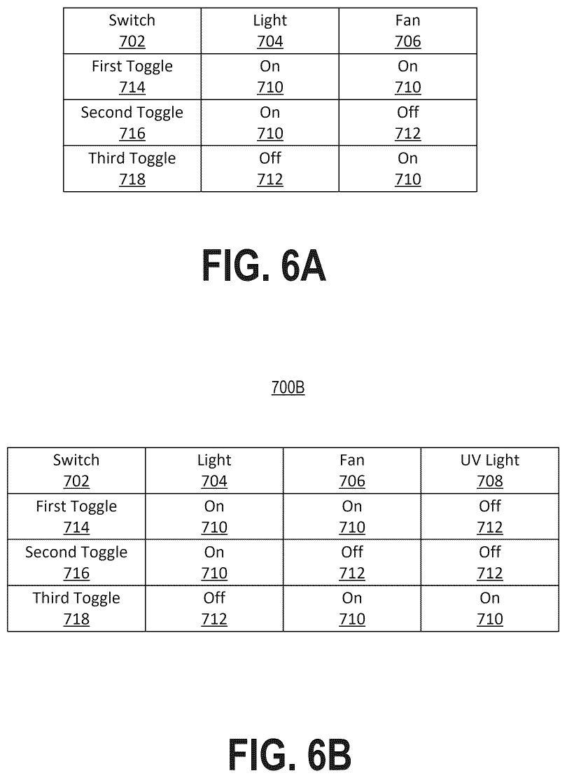

FIG. 5 provides a flowchart illustrating processes and/or procedures for an example method for operating at least one light engine 114 and/or at least one additional operable component (e.g., ceiling fan, UV light, vent fan, nightlight, etc.) of the lighting device 100. For example, the processes and/or procedures illustrated in FIG. 6 are performed by the control unit 118, in an example embodiment. Starting at block 602, the control unit 118 determines that a new activation cycle is being initiated. For example, the control unit 118 may initiate and/or monitor an electrical signal received via a remote switch 40 to identify activation signals therein.

In an example embodiment, the control unit 118 determines that a new activation cycle is being initiated by detecting a change in whether line voltage is being provided to the lighting device 100. For example, the control unit 118 may determine that a new activation cycle is being initiated responsive to determining that a voltage being provided to the lighting device (e.g., by a building electrical system) has changed more than a threshold voltage change. For example, the electrical signal may be a change in the voltage being provided to the lighting device that is equal to or greater than a threshold voltage change.

In an example embodiment, switch 124 is configured to select the preferred operating mode for the lighting device 100. For example, the switch selector 134 may be in the desired switch position 132 (e.g., 132A, 132B, 132C, 132D) when the activation cycle is initiated. For example, the switch 124 may be used to select one of the set operating modes or the configurable operating mode. In an example embodiment, the switch 124 may be used to select a programmable custom operating mode. In some embodiments, a user may be configured to adjust/control the preferred operating mode for the lighting device 100 by engaging with a control unit 118, an interactive element 42 of a remote switch 40, and/or the switch selector 134.

At block 604, a control unit 118 receives at least one activation signal via the electrical signal received via the remote switch 40. For example, at least one activation signal is generated based on user interaction with the interactive element 42 of a remote switch 40 and transmitted to a control unit 118 of the lighting device 100 via the electrical signal received via the remote switch 40. For example, a user may actuate and/or interact with the interactive element 42 of the remote switch 40 (e.g., toggle an on/off switch between the on and off positions thereof) to cause an activation signal to be provided via the electrical signal received by the control unit 118 via the remote switch 40. For example, the interactive element 42 may be a toggle switch that, when in the on position, causes electrical power (e.g., line voltage) to be provided to the lighting device 100 and, when in the off position, causes electrical power to not be provided to the lighting device 100. The activation signal, in an example embodiment, is a momentary (e.g., less than 10 seconds, less than 5 seconds, less than 1 second, and/or the like) break in the provision of electrical power to the lighting device 100.

In an example embodiment, the reception and/or processing of a first activation signal by the control unit 118 may cause the control unit of the lighting device 100 to control/adjust the operation of the lighting device 100 in a first operating mode. In another example, a user may depress/toggle/interact with an interactive element 42 (e.g., button, switch, toggle, and/or the like) to transmit a first signal (e.g., on/off signal) to the lighting device 100, such that reception and/or processing of the first activation signal may cause the one or more light engines 114 and at least one additional operable component (e.g., ceiling fan, UV light, vent fan, nightlight, etc.) to turn on in response to the activation signal. In some embodiments, the lighting device 100 may comprise two or more additional operable components, wherein the lighting device comprises a first operable component (e.g., fan 115 operated via a fan motor 116) and a second operable component (e.g., one or more UV lights 122). In an example embodiment, the light engines 114 and/or additional operable components are turned on as a result of the control unit 118 causing electrical power to be provided thereto (e.g., via a provider circuit 187, driver circuitry 189, and/or the like).

For example, the user may depress an interactive element 42 (e.g., button, switch, toggle, and/or the like) to transmit a first signal (e.g., on/off signal) to the lighting device 100, such that the first signal may cause the one or more light engines 114 and the first operable component (e.g., a fan 115 operated by motor 116) to turn on in response to the activation signal and cause the second operable component (e.g., UV light 122) to remain off. In some embodiments, the one or more UV lights 122 may be configured to turn off automatically after a predetermined amount of time has elapsed and/or in response to a signal received from one or more sensors. For example, if the one or more sensors determine that someone is present in the space where the lighting device 100 is located, the control unit 118 causes the UV light 122 to be turned off, in an example embodiment. For example, responsive to determining that an activation signal has been received, the control unit 118 may cycle the operating mode one step through the cycle of operating modes.

At block 606, it may be determined if a predetermined length of time (e.g., 3 s, 5 s, 10 s, 15 s, 60 s, and/or the like) has elapsed since receipt of the previous activation signal (e.g., since the user depressed/toggled/interacted with the interactive element 42 of the remote switch 40). For example, it may be determined that the predetermined length of time (e.g., 3 s, 5 s, 10 s, 15 s, 60 s, and/or the like) has elapsed since the user depressed the interactive element 42 of the remote switch 40. In an instance in which the predetermined length of time has elapsed, the activation cycle is configured to reset from block 606 back to the beginning (e.g., block 602). For example, a new activation cycle is initiated when it is determined that the predetermined length of time has elapsed since receipt of the (immediately) previous activation signal was received by the control unit 118.

When it is determined that the predetermined length of time has not elapsed since receipt of the (immediately) previous activation signal was received by the control unit 118, the current activation cycle is continued (e.g., not reset/re-initiated). For example, the process continues to block 610.

At block 610, a second activation signal is transmitted from the control unit 118 and/or the interactive element 42 of the remote switch to the lighting device 100. For example, the reception and/or processing of the second activation signal by the control unit 118 may cause the control unit of the lighting device 100 to further control/adjust the operation of the lighting device 100 in a second operating mode. For example, the user may depress/toggle/interact with the interactive element 42 (e.g., button, switch, toggle, and/or the like) to transmit the second signal (e.g., on/off signal) to the lighting device 100. In response to receiving and/or processing the second activation signal, the control unit 118 may cause the one or more light engines 114 to turn on (and/or remain on) and at least one additional operable component (e.g., ceiling fan, UV light, vent fan, nightlight, etc.) to turn off in response to the second activation signal. In an example embodiment, the additional operable components are turned off as a result of the control unit 118 causing electrical power to stop being provided thereto (e.g., via provider circuit 187, driver circuitry 189, and/or the like). For example, when the at least one additional operable component is a fan 115 operated by fan motor 116, the control unit 118 may turn off the fan 115 by ceasing flow of electrical power to the fan motor 116.

In some embodiments, the lighting device 100 may comprise two or more additional operable components, wherein the lighting device comprises a first operable component (e.g., fan 115 operated via fan motor 116) and a second operable component (e.g., one or more UV lights 122). For example, the user may depress/toggle/interact with an interactive element 42 (e.g., button, switch, toggle, and/or the like) to transmit the second activation signal (e.g., on/off signal) to the lighting device 100, such that the second activation signal is received by the control unit 118. In response to receiving and/or processing the second activation signal, the control unit 118 may cause the one or more light engines 114 to remain on, the second operable component (e.g., UV light 122) to turn on, and the first operable component (e.g., a fan operated via motor 116) to turn off in response to the second activation signal receipt and/or processing of the second activation signal by the control unit 118. For example, responsive to determining that a second activation signal has been received, the control unit 118 may cycle the operating mode another step through the cycle of operating modes.

At block 612, it may be determined if a predetermined length of time (e.g., 3 s, 5 s, 10 s, 15 s, 60 s, and/or the like) has elapsed since receipt of the (immediately) previous activation signal (e.g., since the user last depressed/toggled/interacted with the interactive element 42 of the remote switch 40). For example, it may be determined that the predetermined length of time (e.g., 3 s, 5 s, 10 s, 15 s, 60 s, and/or the like) has elapsed since receipt of the (immediately) previous activation signal (e.g., since the user last depressed/toggled/interacted with the interactive element 42 of the remote switch 40). In an instance in which the predetermined length of time has elapsed, the activation cycle is configured to reset from block 612 back to the beginning (e.g., block 602). For example, a new activation cycle is initiated when it is determined that the predetermined length of time has elapsed since receipt of the (immediately) previous activation signal was received by the control unit 118.

When it is determined that the predetermined length of time has not elapsed since receipt of the (immediately) previous activation signal was received by the control unit 118, the current activation cycle is continued (e.g., not reset/re-initiated). For example, the process continues to block 616.

At block 616, a third activation signal may be received by the control unit 118 as a result of a user depressing/toggling/interactive with the interactive element 42 of the remote switch 40. For example, the reception and/or processing of the third activation signal by the control unit 118 may cause the control unit 118 of the lighting device 100 to further control/adjust the operation of the lighting device 100 in a third operating mode. For example, the user may depress/toggle/interact with the interactive element 42 (e.g., button, switch, toggle, and/or the like) to transmit the third activation signal (e.g., on/off signal) to the lighting device 100, such that the third activation signal is received by the control unit 118 via an electrical signal received by the control unit 118 via remote switch 40.

Reception and/or processing of the third activation signal by the control unit 118 may cause the one or more light engines 114 to turn off and at least one additional operable component (e.g., ceiling fan, UV light, vent fan, nightlight, etc.) to turn on. For example, in an example embodiment, in response to receiving and/or processing the third activation signal, the control unit 118 causes electrical power to stop being supplied to the light engines 114 and to be supplied to the at least one additional operable component.

In some embodiments, the lighting device 100 may comprise two or more additional operable components, wherein the lighting device comprises a first operable component (e.g., fan 115 operated via fan motor 116) and a second operable component (e.g., one or more UV lights 122). For example, the user may depress an interactive element (e.g., button, switch, toggle, and/or the like) to transmit the third activation signal (e.g., on/off signal) to the lighting device 100, such that the receipt and/or processing of the third activation signal may cause the one or more light engines 114 to turn off and cause the second operable component (e.g., UV light 122) and the first operable component (e.g., fan 115 operated via fan motor 116) to turn on in response to receiving the third activation signal. For example, responsive to determining that a third activation signal has been received, the control unit 118 may cycle the operating mode a further step through the cycle of operating modes.

In various embodiments, the activation cycle may be configured to reset after the third activation signal has been transmitted to the lighting device. In other embodiments, the activation cycle may comprise one or more additional activation signals. For example, receipt of additional activation signals (e.g., within the predetermined length of time) may cause the control unit 118 to cycle through one or more additional operating modes (e.g., a fourth operating mode, fifth operating mode, and/or the like). Each operating mode is associated with one or more of the light engines 114 and/or additional operable components being supplied with electrical power (e.g., turned on) and/or one or more of the light engines 114 and/or additional operable components not being supplied with electrical power (e.g., turned off). In some embodiments, the switch and/or the remote switch may be turned off and remain turned off for a predetermined amount of time, such that the power to the lighting device is turned off causing power to the one or more light engine and/or the at least one additional operable component to shut off, which may cause the control unit 118 to end the activation cycle.

In certain embodiments, rather than physically interacting with a remote switch 40 in the form of a toggle wall switch, a user may interact with a home automation app, for example, via a computing entity 50. For example, the user may select specific operating mode (e.g., light on and additional operable component on, light off and additional operable component on, light on and addition operable component off, and/or the like) via interaction with the home automation app via the computing entity 50. The computing entity 50 may then control a toggle switch configured to control provision of electrical power (e.g., in the form of line voltage) to cycle the toggle switch to provide a number of activation signals corresponding to the specific operating mode with timing of the activation signals provided in accordance with the timing described with respect to the remote switch 40 in the form of a wall switch.

In an example embodiment, the predetermined length of time is three seconds. In other embodiments, the predetermined length of time may be longer or short than three seconds, as appropriate for the application. Once the lighting device has been operated for a memory update time in a specific operating mode, the lighting device may store the specific operating mode. For example, after the lighting device has been operated for at least a memory update time in the specific operating mode and then the remote switch is turned off, the next time the remote switch is turned on, the lighting device is operated in the specific operating mode. In an example embodiment, the memory update time is ten seconds. The memory update time may be longer or shorter than ten seconds in some embodiments, as appropriate for the application.

### Example Toggle Configuration

FIGS. 6A and 6B depict exemplary toggle configurations of a lighting device 100 in accordance with various embodiments of the present disclosure. In various embodiments, the lighting device 100 may comprise one or more light engines 704 and one additional operable component (e.g., fan 706). In various embodiments, the first toggle 714 of the switch 702 may cause the light engines 704 and the fan 706 to turn on 710. In various embodiments, the second toggle 716 of the switch 702 may cause the light engines 704 to remain on 710 and cause the fan 706 to turn off 712. In various embodiments, the third toggle 718 of the switch 702 may cause the light engines 704 to turn off 712 and cause the fan 706 to turn on.

In various embodiments, the lighting device 100 may comprise one or more light engines 704, a first additional operable component (e.g., fan 706), and a second additional operable component (e.g., UV light 708). In various embodiments, the first toggle 714 of the switch 702 may cause the light engines 704 and the fan 706 to turn on 710 and cause the UV light 708 to remain off. In various embodiments, the second toggle 716 of the switch 702 may cause the light engines 704 to remain on 710 and cause the fan 706 to turn off 712 and cause the UV light 708 to remain off. In various embodiments, the third toggle 718 of the switch 702 may cause the light engines 704 to turn off 712 and cause the fan 706 and the UV light 708 to turn on.

### CONCLUSION

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A lighting device comprising:
a light engine having three or more operating modes;
an accessory comprising at least one additional operable component having at least two operating modes; and
a control unit configured to vary the operating modes of the lighting device in accordance with an activation signal received by the control unit, wherein receipt of the activation signal cycles the lighting device through each of the operating modes.

2. The lighting device of claim 1, wherein the at least one additional operable component comprises at least one of a ceiling fan, a vent fan, or an ultraviolet (UV) light.

3. The lighting device of claim 1, wherein the activation signal comprises a change in voltage that is at least a line voltage threshold voltage change.

4. The lighting device of claim 3, wherein the activation signal is generated by a toggle switch configured to control provision of electrical power to the lighting device.

5. The lighting device of claim 4, wherein the toggle switch is a wall-mounted or junction box mounted switch.

6. The lighting device of claim 4, wherein the toggle switch is configured to be operable via Wi-Fi.

7. The lighting device of claim 1, wherein after the lighting device has been operated in a selected operating mode for at least a memory update time, the control unit stores the selected operating mode to a memory of the control unit for future operation of the lighting device.

8. The lighting device of claim 1, wherein the activation signal causes the control unit to cycle the operating mode to a next operating mode in a sequence of operating modes consisting of the at least two and at least three operating modes.

9. The lighting device of claim 1, wherein the three or more operating modes of the light engine comprise a first operating mode corresponding to the light engine emitting light of a first correlated color temperature (CCT), a second operating mode corresponding to the light engine emitting light of a second CCT, and a third operating mode corresponding to the light engine emitting light of a third CCT.

10. The lighting device of claim 1, wherein at least one of:
the control unit is configured to receive two or more activation signals, wherein a second or subsequent activation signal of the two or more activation signals is received within three seconds of an immediately previous activation signal, or
after the lighting device has been operated in a selected operating mode for at least ten seconds, the control unit stores the selected operating mode to a memory of the control unit for future operation of the lighting device.

11. A lighting device comprising:
a light engine having at least two operating modes;
an accessory comprising at least one additional operable component having three or more operating modes; and
a control unit configured to vary the operating modes of the lighting device in accordance with an activation signal received by the control unit, wherein receipt of the activation signal cycles the lighting device through each of the operating modes.

12. The lighting device of claim 11, wherein the at least one additional operable component comprises a fan and the three or more operating modes of the at least one additional operable component comprise a first operating mode corresponding to operating the fan at high speed, a second operating mode corresponding to operating the fan at medium speed, and a third operating mode corresponding to operating the fan at low speed.

13. The lighting device of claim 11, wherein the at least two operating modes of the light engine include a first operating mode corresponding to the light engine being on and a second operating mode corresponding to the light engine being off.

14. The lighting device of claim 11, wherein the at least one additional operable component comprises a first operable component and a second operable component and the three or more operating modes of the at least one additional operable component comprise a first operating mode corresponding to the first operable component being on and the second operable component being on, a second operating mode corresponding to the first operable component being on and the second operable component being off, and a third operating mode corresponding to the first operable component being off and the second operable component being on.

15. The lighting device of claim 11, wherein the activation signal comprises a change in voltage that is at least a line voltage threshold voltage change.

16. The lighting device of claim 15, wherein the activation signal is generated by a toggle switch configured to control provision of electrical power to the lighting device.

17. A lighting device comprising:
a light engine having two or more operating modes;
an accessory comprising at least one additional operable component having at least two operating modes; and
a control unit configured to vary the operating modes of the lighting device in accordance with an activation signal received by the control unit, wherein receipt of the activation signal cycles the lighting device through each of the operating modes.

18. The lighting device of claim 17, wherein the at least one additional operable component is one of a ceiling fan, a vent fan, or an ultraviolet (UV) light.

19. The lighting device of claim 17, wherein the at least one additional operable component comprises an ultraviolet (UV) light and the control unit is configured to turn off the UV light component after a set period of time has elapsed since the UV light was turned on.

20. The lighting device of claim 17, wherein the activation signal comprises a change in voltage that is at least a line voltage threshold voltage change and the activation signal is generated by a toggle switch configured to control provision of electrical power to the lighting device.
